(19) United States
(12) Patent Application Publication
(10) Pub. No.: US 2026/0134511 A1
(43) Pub. Date: May 14, 2026

(54) DEVICE FOR DETECTING PARTICLES BY MEANS OF LENSLESS IMAGING

(71) Applicant: HORIBA ABX SAS, Montpellier Cedex (FR)

(72) Inventor: Benoît THOUY, Montpellier Cedex (FR)

(21) Appl. No.: 18/996,039

(22) PCT Filed: Jul. 26, 2023
(86) PCT No.: PCT/FR2023/051182

§ 371 Date: Jan. 17, 2025

(30) Foreign Application Priority Data
Jul. 29, 2022 (FR) FR2207853

(51) Int. Cl. G06T 5/50; G06T 5/20; G06T 7/00

(52) U.S. Cl. CPC G06T 5/50; G06T 5/20; G06T 7/0012; G06T 2207/30004

(57) ABSTRACT

The invention relates to a device for detecting particles by means of lensless imaging, the device comprising a memory (4) arranged to receive a plurality of z-stack images obtained from a lensless image of a biological sample, a picker (6) arranged to determine, on the basis of the z-stack images, a focus image in which each pixel is associated on the one hand with a z-stack image and on the other hand with the intensity of this pixel in this z-stack image, the picker (6) being arranged to determine the z-stack image for a given pixel by calculating, for each of the z-stack images and for the given pixel, the parsimony score on the basis of the intensity of the given pixel and on the intensities of neighbouring pixels, and by selecting the z-stack image for which the parsimony score is highest, a selector (10) arranged to determine, for each pixel of the focus image, whether this pixel is a maximum in a local neighbourhood centred on this pixel in the focus image or in the z-stack image associated with this pixel in the focus image, and, if if it is, to store this pixel in a list of selected sites, and a computer (12) arranged to calculate a metric value for each pixel in the list of selected sites on the basis of the intensity of these pixels to produce an image of the metric values for distinguishing the particles associated with each pixel in the list of selected sites from one another.

The invention relates to the field of image processing of samples, in particular biological samples, by lensless imaging.

Lensless imaging consists in placing a sample between a light source and an image sensor without an optical magnification device between the sample and the image sensor. The image sensor thus collects an image of the light intensity transmitted by the sample, also called a hologram, which is formed of interference patterns between, on the one hand, the light wave emitted by the light source and transmitted by the sample, and, on the other hand, diffraction waves resulting from the diffraction by the sample of the light wave emitted by the light source.

These interference patterns have been the subject of research in order to reconstruct an image allowing exploiting the information they contain on the observed sample. This technique, due to its material simplicity related to the absence of optics, is considered particularly promising, and has been the subject of numerous developments in the field of haematology.

Counting red blood cells (hereinafter “RBC”) is possible in the context of Platelet Rich Plasma (hereinafter “PRP”) control, because the number of RBCs is low enough not to mask the other particles. In the case of whole blood, it is necessary to lyse them, and it is then possible to count only the platelet populations (hereinafter “PLT”) and white blood cells (hereinafter “WBC”), with the additional difficulty of having a background noisy by the lysed RBCs.

The patents published under numbers FR 3 034 196 and FR 3 049 348 teach a calculation of statistics from detected cells, in particular from z-profiles, for counting and differentiating WBCs. Unlike the state of the art, these methods require a prerequisite: the reconstruction of the image from the diffraction image with an accurate method, capable of preserving the local information of the quasi-point particles and not leaving any major artifacts. By way of example, patent FR 3 049 347 teaches such a reconstruction method.

To date, only the WBC-PLT method described in patent FR 3 082 943 allows counting PLTs on PRP and in lysed blood (with a different setting), and an additional work would be necessary to know how to discriminate RBCs (in PRP) and other particles. This method is based on the detection of particles in a stack of images reconstructed around a mean plane; the detection planes are then merged to establish a detection map. This map is directly used for counting particles. In the case where several types of particles are present, it is appropriate to adapt this general strategy to each type of particle. On each object (connected component) of the detection mask thus calculated, metrics are calculated in order to determine the nature of the objects or their number. This last point constitutes an extremely penalising limit: in the case of an image containing a large number of particles, many particle multiplets are (statistically) present and the method does not address this problem in the case where several types of particles are present. Finally, attempts to use this method on lysed blood have been unsuccessful.

Another method has been developed and is based on a deep neural network (DNN) model. The training was done on an augmented sample base to have enough inputs, taking into account the counts given by a reference machine. The performances were very good, but they are limited by the hypothesis specific to this type of method: having enough training data with a sufficiently reliable reference. The data acquisition is a long and expensive process, and it is the limiting factor for the application of DNN-based technologies. In addition, training is strongly influenced by the reference machine, which poses a problem with regard to the variability of the measuring machines. Furthermore, since training is carried out on images with noise, it therefore induces training of the noise of the lysis and not only of the counting and classification. Finally, this training allows carrying out a counting, but not the classification of particles because there is no constructible reference.

No solution therefore offers full satisfaction for PLT counting in the context of lensless imaging in whole blood.

The invention improves the situation. To this end, it proposes a device for detecting particles by means of lensless imaging, comprising a memory arranged to receive a plurality of z-stack images obtained from a lensless image of a biological sample, an initiator arranged to determine, on the basis of said z-stack images, a focus image in which each pixel is associated, on the one hand, with a z-stack image and, on the other hand, with the intensity of this pixel in this z-stack image, the initiator being arranged to determine the z-stack image for a given pixel by calculating, for each of the z-stack images and for the given pixel, a parsimony score on the basis of the intensity of the given pixel and on the intensities of neighbouring pixels, and by selecting the z-stack image for which the parsimony score is the highest, a selector arranged to determine, for each pixel of the focus image, whether this pixel is a maximum in a local neighbourhood centred on this pixel in the focus image or in the z-stack image associated with this pixel in the focus image, and, if this is the case, to store this pixel in a list of selected sites, and a computer arranged to calculate a metric value for each pixel in the list of selected sites based on the intensity of these pixels to allow producing an image of the metric values allowing distinguishing the particles associated with each pixel in the list of selected sites from one another.

This device is particularly advantageous because it allows carrying out a reliable count of PLTs and which can be embedded in a laboratory device.

According to various embodiments, the invention may have one or more of the following features:
the computer arranged to implement a metric being chosen from a metric based on the modelling of the intensities of a neighbourhood of each pixel in the list of selected sites in the z-stack image associated with this pixel in the focus image by a Gaussian, by combining one or more of the covariance, the height and the eccentricity factor of this Gaussian, and a metric based on the mean of the z-gradients of the intensity of the pixels of a neighbourhood centred on each pixel in the list of selected sites, which gradient is evaluated for the z-stack image corresponding to each pixel in the list of selected sites in the focus image,
the initiator is arranged to use a parsimony score based on the pq mean where the intensities are modulated by a Gaussian window centred on the given pixel,
the initiator is arranged to use a pq mean with p equal to ½ and q equal to 3, a square neighbourhood of 17 pixels, and a Gaussian of standard deviation equal to 2.5,
the selector is arranged to browse the list of selected sites, and, when two pixels are immediately neighbours, to keep the one whose associated intensity in the focus image is the most significant, and
the device further comprises a filter arranged to recalculate the focus image by recalculating the parsimony score for each given pixel by restricting the pixel neighbourhood to pixels whose associated z-stack image in the focus image is identical to that associated with the given pixel or immediately neighbouring in z.

The invention also relates to a method for detecting particles by means of lensless imaging, comprising the following operations:
a) receiving a plurality of z-stack images obtained from a lensless image of a biological sample,
b) determining a focus image in which each pixel is associated, on the one hand, with a z-stack image and, on the other hand, with the intensity of this pixel in this z-stack image, this determination being carried out, for a given pixel,
b1) by calculating, for each of the z-stack images and for the given pixel, a parsimony score from the intensity of the given pixel and the intensities of neighbouring pixels, and
b2) by selecting the z-stack image for which the parsimony score is the highest,
c) determining, for each pixel of the focus image, whether this pixel is a maximum in a local neighbourhood centred on this pixel in the focus image or in the z-stack image associated with this pixel in the focus image, and, if this is the case, to store this pixel in a list of selected sites, and
d) calculating a metric value for each pixel in the list of selected sites based on the intensity of these pixels to allow producing an image of the metric values allowing distinguishing the particles associated with each pixel in the list of selected sites from one another.

According to various embodiments, the invention may have one or more of the following features:
in operation d), the metric is selected from a metric based on modelling the intensities of a neighbourhood of each pixel in the list of selected sites in the z-stack image associated with this pixel in the focus image by a Gaussian, by combining one or more of the covariance, height, and eccentricity factor of this Gaussian, and a metric based on the mean of the z-gradients of the intensity of the pixels of a neighbourhood centred on each pixel in the list of selected sites, which gradient is evaluated for the z-stack image corresponding to each pixel in the list of selected sites in the focus image
operation b1) uses a parsimony score based on the pq mean where the intensities are modulated by a Gaussian window centred on the given pixel,
operation b1) uses the pq mean as a parsimony score, with p equal to ½ and q equal to 3, a square neighbourhood of 17 pixels, and a Gaussian of standard deviation equal to 2.5,
operation c) comprises browsing the list of selected sites, and, when two pixels are immediately neighbours, to keep the one whose associated intensity in the focus image is the most significant, and
operation b) further comprises b3) recalculating the focus image by recalculating the parsimony score for each given pixel by restricting the pixel neighbourhood to pixels whose associated z-stack image in the focus image is identical to that associated with the given pixel or immediately neighbouring in z.

The invention also relates to a computer program comprising instructions for executing the method according to the invention, a data storage medium on which such a computer program is recorded and a computer system comprising a processor coupled to a memory, the memory having recorded such a computer program.

Other features and advantages of the invention will become more apparent on reading the following description, taken from examples given for illustrative and non-limiting purposes, taken from the drawings in which:

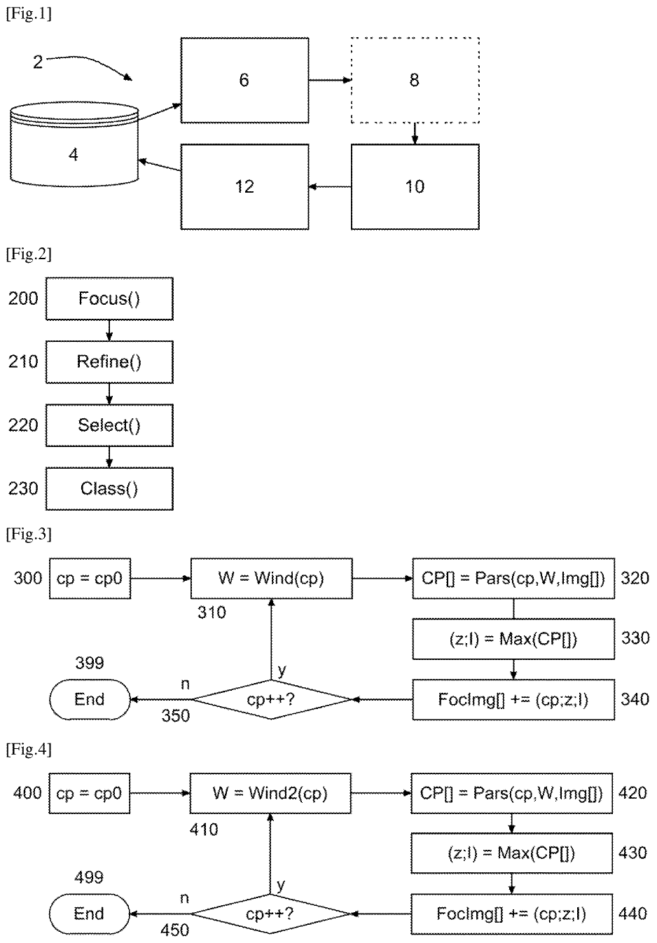

FIG. 1 represents a generic diagram of a device according to the invention,

FIG. 2 represents an example of an operating loop of the device of FIG. 1,

FIG. 3 represents an example of implementation of a function implemented in a first operation of FIG. 2,

FIG. 4 represents an example of implementation of a function implemented in a second operation of FIG. 2,

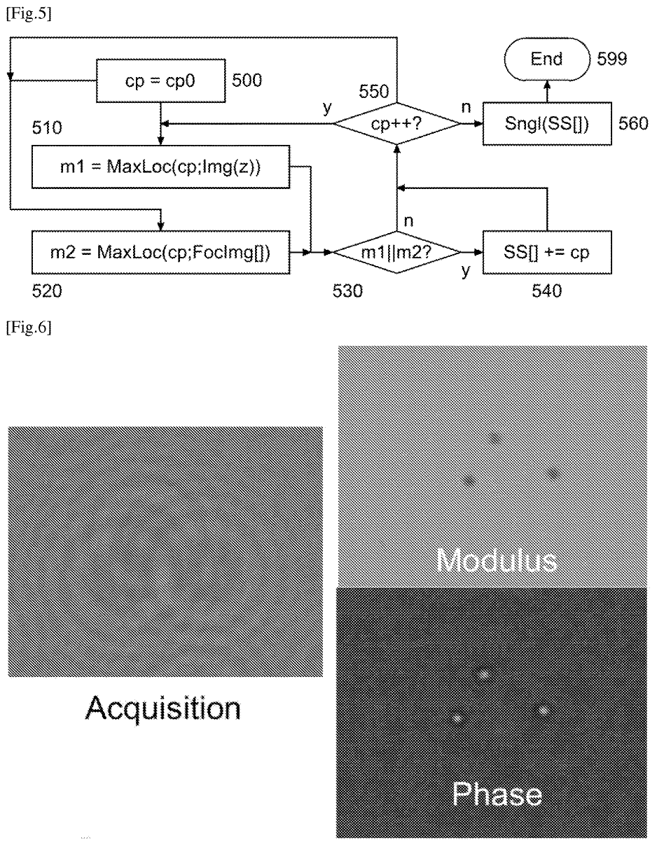

FIG. 5 represents an example of implementation of a function implemented in a third operation of FIG. 2,

FIG. 6 represents a lensless image, and z-stack images derived therefrom,

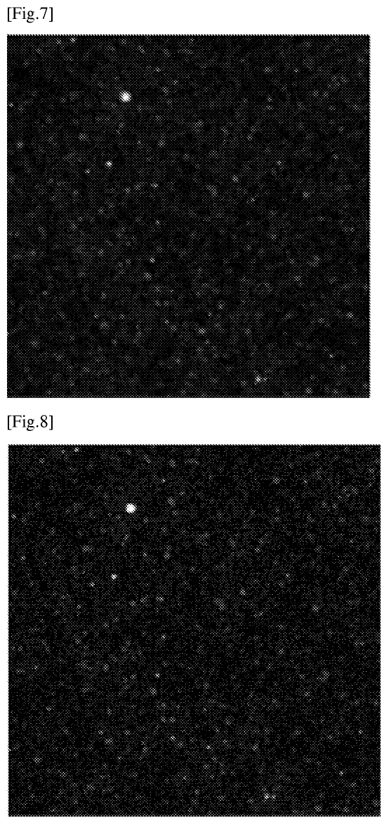

FIG. 7 represents a focus image obtained by the function of FIG. 3,

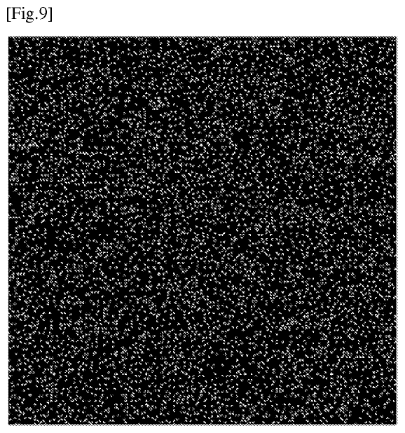

FIG. 8 represents a focus image obtained by the function of FIG. 4,

FIG. 9 represents a focus image obtained by the function of FIG. 5,

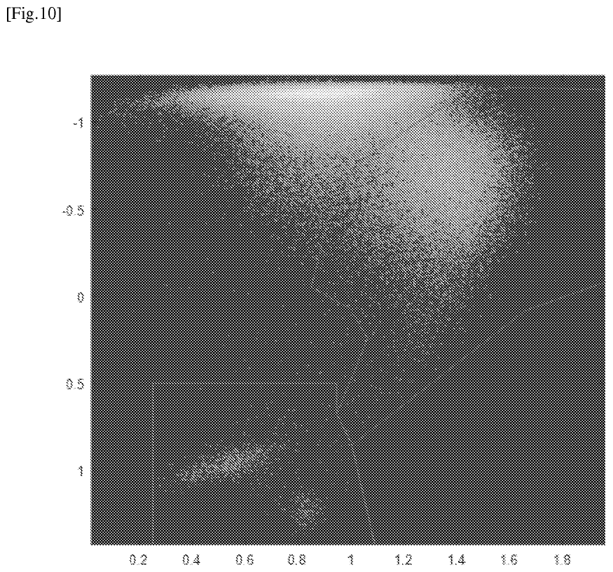

FIG. 10 represents an image of first metric values obtained from an image obtained by the function of FIG. 5, and

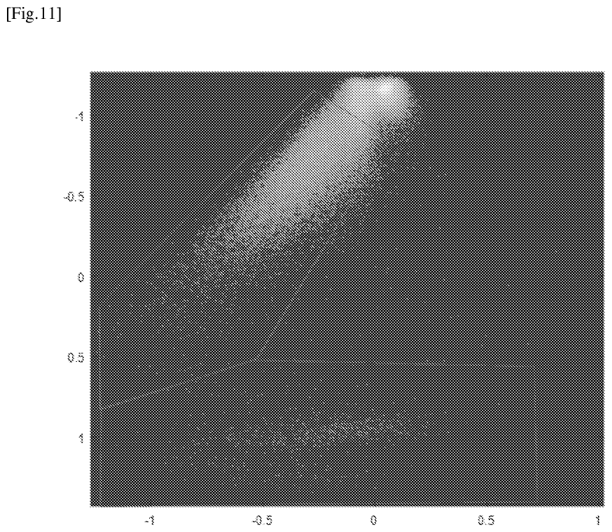

FIG. 11 represents an image of second metric values obtained from an image obtained by the function of FIG. 5.

The drawings and the description below contain, for the most part, elements of a certain nature. They may therefore not only serve to better understand the present invention, but also contribute to its definition, where appropriate.

The present description is likely to involve elements likely to be protected by copyright. The rights holder has no objection to the identical reproduction by anyone of this patent document or its description, as it appears in the official files. For the rest, he reserves his rights in full.

FIG. 1 represents a generic diagram of a device 2 according to the invention. The device 2 comprises a memory 4, an initiator 6, a filter 8, a selector 10 and a computer 12. As will be seen below, the filter 8 is optional.

The memory 4 receives the data which are the subject of the functions and calculations implemented by the device 2. The device 2 mainly processes reconstructed images whose focus is taken at various depths, obtained from a lensless image. The patent published under number FR 3 082 944 describes an example of implementation of this type of image. More specifically, this patent describes how, from a lensless image, a plurality of images that will be called below “z-stack images” or “z-focus images” are reconstructed and correspond to a focusing of the lensless imaging at a particular depth.

FIG. 6 shows an acquisition image from the lensless imaging, and images of the module and the phase which are reconstructed from the acquisition image. As will be seen below, these are images that combine the module and the phase that are used as z-stack images in the context of the invention. Alternatively, only the phase image or only the module image could be used when it carries the information of interest.

The difficulty in processing these images lies in the fact that the platelets constitute elements whose size is in the range of a pixel, whose number is very high, all in an image whose background is very noisy due to the lysis of the RBCs, which makes it impossible to differentiate with the naked eye between the PLTs, on the one hand, and the RBC debris, on the other hand. The data of the z-stack images comprise, on the one hand, pixels identified by the coordinates thereof, and, on the other hand, an intensity value associated with these pixels. In the example described here, the images have a resolution of 3840×2748 pixels, and the intensity is modified: the z-stack image is processed in the form |I−1| instead of III because the image without particles after reconstruction must theoretically have a constant value at 1. Thus, by working on |I−1|, the amplitude of the disturbance locally induced by the diffraction is considered.

The memory 4 can be any type of data storage suitable for receiving digital data: hard disk, hard disk flash memory, flash memory drive in any form, RAM, magnetic disk, locally or cloud distributed storage, etc.

In the example described here, the memory 4 receives all data described above, and more generally all data concerning the device 2, that is to say the programs and software instantiating the initiator 6, the filter 8, the selector 10 and the computer 12, their parameters, the received input data, the output data, as well as the data stored in buffer memory. The data calculated by the device can be stored on any type of memory similar to the memory 4, or thereon. These data can be erased after the device has performed its tasks or kept.

The initiator 6, the filter 8, the selector 10 and the computer 12 directly or indirectly access the memory 4. They can be implemented in the form of an appropriate computer code executed on one or more processors. The term “processors” means any processor adapted to the calculations described below. Such a processor can be implemented in any known manner, in the form of a microprocessor for a personal computer, laptop, tablet or smartphone, a dedicated chip of the FPGA or SoC type, a computing resource on a grid or in the cloud, a cluster of graphics processors (GPUs), a microcontroller, or any other form suitable for providing the computing power necessary for the implementation described below. One or more of these elements can also be implemented in the form of specialised electronic circuits such as an ASIC. A combination of processor and electronic circuits could also be considered. Processors dedicated to machine learning could also be considered.

The initiator 6, the filter 8, the selector 10 and the computer 12 are presented here separately because they perform distinct functions. This modular description aims at better understand the functional blocks implemented by the device 2. It goes without saying that two or more of these elements could nevertheless be grouped together as long as the functional relationships remain comparable.

FIG. 2 shows an example of an operating loop of the device of FIG. 1 allowing better understanding the respective functions of the initiator 6, the filter 8, the selector 10 and the computer 12.

The loop begins in an operation 200 in which the initiator 6 executes a Focus( ) function. The Focus( ) function accesses the z-stack images from the same lensless image, and returns an image called a focus image, in which for each pixel are associated, on the one hand, a z-stack image index and, on the other hand, the intensity of this pixel in this z-stack image. The purpose of the Focus( ) function is to identify, for each pixel, what is the best focus depth, in order to find the most relevant plane to deduce the nature of each pixel. This function will be described further with FIG. 3. FIG. 7 shows an example of an obtained focus image.

Then, the focus image is reprocessed in an optional operation 210 in which the filter 8 executes a Refine( ) function. As will be seen below, the Focus( ) function uses a parsimony score coupled with a Gaussian window, which allows having a good quality focus image while preserving a certain regularity, without which the pixels of the same cell are not necessarily at the same focus. However, in the context of platelet detection this regularity has a price. Indeed, because of the large number of cells present in the chamber, the distance between two cells can be very small, and a cell can easily be in the neighbouring window and interfere with the parsimony score. The Gaussian window reduces this phenomenon, but if two cells are a few pixels apart, the more “intense” one will take precedence over the other and the less “intense” one will probably have a non-optimal focus. The Refine( ) function aims at solving this problem by refining the focus image from the focus planes found in operation 200, and by only taking into account pixels in identical or very close planes for the parsimony score of each pixel. This function will be described further with FIG. 4. FIG. 8 shows an example of a refined focus image.

The selector 10 then uses the focus image—possibly refined—to choose the pixels that form likely platelet sites. To do this, the selector 10 executes a Selec( ) function in an operation 220. This function promotes a pixel detection and not by connected component, in order to be able to best process multiplet cases as simply as possible. The important thing is not to “forget” any sites, and to consider the objects to be searched as unique pixels, in order to relegate the operation of distinguishing between object pixels (platelets) and background pixels to the final operation. This function will be described further with FIG. 5. FIG. 9 shows an example of an image of sites which is obtained.

Finally, in an operation 230, the computer 12 uses the list of sites determined by the selector 10, and executes a Class( ) function in which metrics are calculated in order to produce an image allowing distinguishing between platelet pixels and background pixels. This operation therefore also allows counting the PLTs and estimating their concentration. FIGS. 10 and 11 show classification images obtained for two distinct metrics.

FIG. 3 shows an example of implementation of the Focus( ) function executed by the initiator 6. As explained above, the purpose of this function is, from the z-stack images, to determine for each pixel the focus plane in z that is most suitable therefor. To do this, the Applicant has discovered that a parsimony score applied to a neighbourhood of points of each pixel allows obtaining unmatched results. The parsimony score has the advantage of being adapted to pixel objects because it seeks to maximise the level of a single pixel to the detriment of all others. Several parsimony scores exist, and the Focus( ) function described here uses a modified version of the pq-mean measure (or pq mean). The pq mean has good theoretical properties while being fairly simple to calculate, which allows easily embedding it in a machine. Thus, in the example described here, the used measure has the following formula:

$$Pars ( X ) = 1 - \frac{{‖ G * {X}^{p} ‖}^{1 / p}}{{‖ G * {X}^{q} ‖}^{1 / q}}$$

where X represents a neighbourhood comprising all intensities around a given pixel, G is a Gaussian window that is applied to the intensities of the pixels of the neighbourhood, * designates the convolution product, and p and q are the parameters of the parsimony score, with 0<p≤1<q.

In the example described here, the Applicant has identified that p=½ and q=3 give the best results.

Other combinations nevertheless offer good results, such as p=⅓ and q=4 or p=½ and q=4. In the case of pixel searches, the dimension of the neighbourhood was here determined from the Gaussian. Thus, starting from a standard deviation of 2.5, for a Gaussian covering 3 sigmas—which represents the conventional approach—a neighbourhood of 17 pixels (3 times 2.5 rounded 8, 2 times plus the central pixel) is obtained. Other Gaussian window dimensions could be retained.

Thus, in a first operation 300, a first current pixel cp is initialised with the first pixel cp0 in the coordinates of the z-stack images, then in an operation 310, a Wind( ) function retrieves all neighbours in a square window of 17 pixels centred on the pixel cp and records their intensities in a variable W. The variable W receives the neighbourhoods for all z-stack images, such that all z-stack images are processed at once. Alternatively, the z-stack images could be processed sequentially or in parallel, and the choice of focus would then be made after all these calculations.

Then, the parsimony score is calculated by a Pars( ) function in an operation 320. The result is stored in an array CP[ ] which therefore receives, for each depth of focus z corresponding to a z-stack image, on the one hand, the parsimony score of pixel cp in the considered z-stack image, and, on the other hand, by the intensity of the pixel cp in the considered z-stack image.

The initiator 6 then executes a Max( ) function in an operation 330. The Max( ) function goes through the array CP[ ] and returns the couple (z; I) (where I is the intensity stored in the array CP[ ] for the concerned z-stack image) for which the parsimony score is the highest. Indeed, the z-stack image for which the parsimony score is the highest is the image in which this pixel has the best focus. Alternatively, it would be possible to determine the z corresponding to the maximum intensity by interpolating the curve of values I, and, if necessary, interpolating intensity values in this plane for the rest of the calculations. In the latter case, this new plane can be introduced into the z-stack image data, where only a neighbourhood of the point considered can be retained, this neighbourhood being described below.

The triplet (cp; z; I) is then stored in an array FocImg[ ] in an operation 340. As it appears, the array FocImg[ ] contains all information of the focus image and is progressively built. In what follows, the array FocImg[ ] will be able to designate the focus image.

Finally, the next pixel is retrieved in an operation 350, and the Focus( ) function resumes with operation 310, unless all pixels have been processed, in which case it ends in an operation 399.

In the above, the Focus( ) function processes the pixels sequentially. It goes without saying that a parallelised version of this processing is possible. Thus, the focus image FocImg[ ] has a frame 8 pixels thick in which no z is identified since all measurements are zero. This has the advantage of limiting the risks of edge effects. At the end of processing by the device 2, a frame 35 pixels thick is removed during counting. This nevertheless remains negligible compared to the dimensions of the considered images (10 MP). The Applicant has also identified that the pq mean is not the only parsimony score that gives satisfactory results. Thus, the Gini measure (or Gini index), also coupled with a Gaussian windowing is a variant that is part of the scope of the invention.

FIG. 4 shows an example of implementation of the optional executed Refine( ) function implemented by the filter 8. In fact, this function is extremely close to the Focus( ) function. Also, similar or identical operations have reference numbers of which only the hundreds digit changes, and only the differences will be described.

The only difference between the Focus( ) function and the Refine( ) function lies in the definition of the neighbourhood window. Thus, in operation 410, the filter 8 executes a Wind2( ) function that defines the window W differently. Indeed, as the goal is to only take into account neighbours that are in the same focus plane as the pixel cp or close (for example one plane away), the Wind2( ) function defines the window W in a similar way to the Wind( ) function, but, at each pixel, it retrieves the value z of this pixel in the focus image FocImg[ ], and discards the pixel if this z is distinct from the z of the z-stack image of the current pixel cp. Thus, for each z-stack image, the parsimony score is refined for each pixel with only the pixels that are potentially relevant.

The Refine( ) function can be repeated until a threshold of modification of the parsimony scores is reached. Alternatively, this function can be repeated a fixed number of times. The Applicant has discovered that 4 executions offer the best ratio between improvements and computational cost. The main gain offered by the Refine( ) function is the improvement of the bias in the linear regression of measurements by the device 2. Indeed, the tests on existing databases carried out by the Applicant have shown that the bias (ordinate at the origin of the linear regression) goes from 35 gigaplatelets per L to 24 gigaplatelets per L with the Refine( ) function, this bias being ideally 0. In the context of an embedded use, the Refine( ) function can nevertheless be omitted because its computational cost is very high. Gaussian windowing is of less interest in the Refine( ) function and can be relaxed, either fixedly or progressively at each iteration.

FIG. 5 shows an example of implementation of the Selct( ) function executed by the selector 10. Now that the focus image is determined, the goal is to identify among the pixels those that correspond to potential platelet sites. This amounts to performing a search for local maxima.

Thus, in a first operation 500, a first current pixel cp is initialised with the first pixel cp0 in the coordinates of the z-stack images, then two operations 510 and 520 are launched in parallel. In operation 510, a MaxLoc( ) function determines a Boolean value indicating whether the current pixel cp constitutes a local maximum in the z-stack image whose depth is that associated with the current pixel cp in the focus image FocImg[ ]. This is done by comparing the intensity I of the current pixel cp to the intensity of all connected pixels. Operation 520 is very close, except that the neighbourhood is taken on the focus image FocImg[ ] itself, and no longer the z-stack image of the focus of the current pixel cp. Then, the values m1 from operation 510 and m2 from operation 520 are compared with a logical OR in operation 530. This test is therefore positive if one of the two values m1 and m2 is equal to 1. Indeed, two neighbouring pixels do not necessarily have the same focus, and it is possible to have pixels which are local maxima on the focus image, but not on the image of the focus plane thereof.

If the test of operation 530 is positive, then the pixel cp is added in an operation 540 to an array SS[ ] of selected sites, then a test in an operation 550 determines if there are any current pixels left to be processed. If so, the Select( ) function resumes with operations 510 and 520 for the new current pixel. Otherwise, a Sng1( ) function is executed in an operation 560. The Sng1( ) function is used to take into account the fact that, among the selected pixels, it happens quite often that two pixels are on the same particle. Consequently, once the list SS[ ] is stopped, the Sng1( ) function scans it to identify the pairs of directly neighbouring and selected pixels, and keeps the one with the greatest intensity in the focus image FocImg[ ]. Finally, the Select( ) function ends in an operation 599.

In the above, the Select( ) function processes the pixels sequentially. It goes without saying that a parallelised version of this processing is possible. In addition, in order to provide a visually meaningful representation, the SS[ ] list that is output can be assimilated to an image of sites in which the selected sites have a value 1 and the other pixels have a zero value. Here again, the image of sites and the SS[ ] list can be used interchangeably or jointly, as they designate the same thing. Alternatively, operation 560 could be omitted.

Once the image of sites has been determined, it remains to apply a metric allowing classifying the pixels as particles or as background. The Applicant has carried out extensive research, and has identified two families of metrics that can discriminate particles.

The first family is of Gaussian nature, and includes two metrics:
a first metric in which for each site, a neighbourhood centred on the site of dimensions 3×3 (alternatively, a 5×5, 7×7 or other window can be used to detect particles of different sizes) of the intensities in the z-stack image associated with the site in the focus image FocImg[ ] is modelled by a Gaussian whose inverse of the standard deviation constitutes the metric,
a second metric in which for each site, a 3×3 neighbourhood of the intensities in the z-stack image associated with the site in the focus image FocImg[ ] is modelled by a Gaussian whose height constitutes the metric. Alternatively, the metric can also be based on the variance divided by the height.

FIGS. 10 and 11 show how these two metrics allow separating PLT, WBC and background, with added separation zones.

The second family is based on the z-gradient. In this version, the z-gradient is calculated for each pixel of a neighbourhood centred on each site, of dimension 3×3, with the intensities of these pixels in the respective z-stack images, this gradient being evaluated around the z-depth associated with the site in the focus image FocImg[ ]. The metric is then defined as the mean of the calculated gradients.

For example, other families of metrics could be considered. In particular, metrics could be calculated on neighbourhoods other than 3×3 neighbourhoods, and the metrics calculated on these neighbourhoods could be of a nature other than the modelling by a Gaussian. The chosen neighbourhoods could thus be projected onto different bases, such as, but without limitation to: the frequency base of the Fourier transform, a base formed by a series of orthogonal polynomials, a decomposition of the neighbourhood into wavelets.

The device and the method according to the invention can be used on other types of samples desired to be characterised. These samples can in particular include a medium in which particles bathe. The medium can be a liquid medium. It can comprise a body fluid, obtained for example from blood or urine or lymph or cerebrospinal fluid. It may also be a culture medium, including nutrients allowing the development of microorganisms or cells. The term “particle” means in particular, and without limitation:
a cell, whether it is a culture cell or a body cell, for example a blood cell;
a microorganism, for example a bacterium or a yeast or a microalgae;
a solid particle, for example a microbead, the microbead being able to be functionalised, so as to promote grafting with an analyte; or even
a particle forming an emulsion in the medium, in particular a particle insoluble in the medium, an example being a lipid droplet in an aqueous medium.

1. A device for detecting particles by means of lensless imaging, comprising a memory arranged to receive a plurality of z-stack images obtained from a lensless image of a biological sample, an initiator arranged to determine, on the basis of said z-stack images, a focus image in which each pixel is associated, on the one hand, with a z-stack image and, on the other hand, with an intensity of this pixel in this z-stack image, the initiator being arranged to determine the z-stack image for a given pixel by calculating, for each of the z-stack images and for the given pixel, a parsimony score on the basis of the intensity of the given pixel and on the intensities of neighbouring pixels, and by selecting the z-stack image for which the parsimony score is highest, a selector arranged to determine, for each pixel of the focus image, whether this pixel is a maximum in a local neighbourhood centred on this pixel in the focus image or in the z-stack image associated with this pixel in the focus image, and, if this is the case, to store this pixel in a list of selected sites, and a computer arranged to calculate a metric value for each pixel in the list of selected sites based on the intensity of these pixels to allow producing an image of the metric values allowing distinguishing the particles associated with each pixel in the list of selected sites from one another.

2. The device according to claim 1, wherein the computer is arranged to implement a metric being chosen from a metric based on modelling of the intensities of a neighbourhood of each pixel in the list of selected sites in the z-stack image associated with this pixel in the focus image by a Gaussian, by combining one or more of covariance, height and eccentricity factor of this Gaussian, and a metric based on a mean of z-gradients of the intensity of the pixels of a neighbourhood centred on each pixel in the list of selected sites, which gradient is evaluated for the z-stack image corresponding to each pixel in the list of selected sites in the focus image.

3. The device according to claim 1, wherein the initiator is arranged to use a parsimony score based on a pq mean where the intensities are modulated by a Gaussian window centred on the given pixel.

4. The device according to claim 3, wherein the initiator is arranged to use a pq mean with p equal to ½ and q equal to 3, a square neighbourhood of 17 pixels, and a Gaussian of standard deviation equal to 2.5.

5. The device according to claim 1, wherein the selector is arranged to browse the list of selected sites, and, when two pixels are immediate neighbours, to keep the one whose associated intensity in the focus image is most significant.

6. The device according to claim 1, further comprising a filter arranged to recalculate the focus image by recalculating the parsimony score for each given pixel by restricting the pixel neighbourhood to pixels whose associated z-stack image in the focus image is identical to that associated with the given pixel or immediately neighbouring in z.

7. A method for detecting particles by means of lensless imaging, comprising the following operations:
a) receiving a plurality of z-stack images obtained from a lensless image of a biological sample,
b) determining a focus image in which each pixel is associated, on the one hand, with a z-stack image and, on the other hand, with intensity of this pixel in this z-stack image, this determination being carried out, for a given pixel,
b1) by calculating, for each of the z-stack images and for the given pixel, a parsimony score from the intensity of the given pixel and the intensities of neighbouring pixels, and
b2) by selecting the z-stack image for which the parsimony score is highest,
c) determining, for each pixel of the focus image, whether this pixel is a maximum in a local neighbourhood centred on this pixel in the focus image or in the z-stack image associated with this pixel in the focus image, and, if this is the case, to store this pixel in a list of selected sites, and
d) calculating a metric value for each pixel in the list of selected sites based on the intensity of these pixels to allow producing an image of the metric values allowing distinguishing the particles associated with each pixel in the list of selected sites from one another.

8. The method according to claim 7, wherein in operation d), the metric is selected from a metric based on modelling the intensities of a neighbourhood of each pixel in the list of selected sites in the z-stack image associated with this pixel in the focus image by a Gaussian, by combining one or more of covariance, height, and eccentricity factor of this Gaussian, and a metric based on the mean of z-gradients of the intensity of the pixels of a neighbourhood centred on each pixel in the list of selected sites, which gradient is evaluated for the z-stack image corresponding to each pixel in the list of selected sites in the focus image.

9. The method according to claim 7, wherein operation b1) uses a parsimony score based on a pq mean where the intensities are modulated by a Gaussian window centred on the given pixel.

10. The method according to claim 9, wherein operation b1) uses the pq mean as a parsimony score, with p equal to ½ and q equal to 3, a square neighbourhood of 17 pixels, and a Gaussian of standard deviation equal to 2.5.

11. The method according to claim 7, wherein operation c) comprises browsing the list of selected sites, and, when two pixels are immediately neighbours, to keep the one whose associated intensity in the focus image is most significant.

12. The method according to claim 7, wherein operation b) further comprises b3) recalculating the focus image by recalculating the parsimony score for each given pixel by restricting the pixel neighbourhood to pixels whose associated z-stack image in the focus image is identical to that associated with the given pixel or immediately neighbouring in z.

13. A computer program comprising instructions for executing the method according to claim 7 when implemented by computer.

14. A data storage medium on which the computer program according to claim 13 is recorded.
